(19) United States
(12) Patent Application Publication
(10) Pub. No.: US 2023/0296743 A1
(43) Pub. Date: Sep. 21, 2023

(54) APPARATUS AND METHOD FOR CALIBRATING DISTORTION OF POLYGONAL MIRROR ROTATING LiDAR SENSOR

(71) Applicant: HL Klemove Corp., Incheon (KR)

(72) Inventors: YUN KI HAN, Suwon (KR); HoSeok Shin, Suwon (KR); Hak Gu Han, Namyangju (KR); Yong Min Park, Seongnam (KR); Hyuk Ryu, Seoul (KR)

(21) Appl. No.: 18/183,986

(22) Filed: Mar. 15, 2023

(30) Foreign Application Priority Data
Mar. 15, 2022 (KR) 10 2022 0031924

(51) Int. Cl. G01S 7/497; G02B 26/12; G01S 7/484; G01S 7/4865

(52) U.S. Cl. CPC G01S 7/497; G02B 26/121; G01S 7/484; G01S 7/4865

(57) ABSTRACT

Provided are an apparatus and method for calibrating distortion of a polygonal mirror rotating light wave detection and ranging (LiDAR) sensor. The apparatus includes a polygonal mirror rotating LiDAR fixedly installed at a predetermined position and replaceable, and a calibration reference model fixedly installed at a predetermined position and including a vertical pillar to be detected by the polygonal mirror rotating LiDAR sensor, in which the polygonal mirror rotating LiDAR sensor includes a controller configured to obtain n pieces of scan data using n polygonal mirrors (n is an integer greater than or equal to 2) and calibrate positions of the vertical pillar in pieces of scan data on the basis of position data of the vertical pillar in a specific piece of scan data among the n pieces of scan data.

### CROSS-REFERENCE TO RELATED APPLICATION

This application claims priority to and the benefit of Korean Patent Application No. 2022-0031924, filed on Mar. 15, 2022, the disclosure of which is incorporated herein by reference in its entirety.

### BACKGROUND

### 1. Field of the Invention

The present disclosure relates to an apparatus and method for calibrating distortion of a polygonal mirror rotating light wave detection and ranging (LiDAR) sensor and, more particularly, to an apparatus and method for calibrating an error between sides of a mirror that reflect light.

### 2. Discussion of Related Art

In general, a machine-rotating light wave detection and ranging (LiDAR) sensor used in various industrial fields secures a horizontal viewing angle by rotating a mirror by a motor or rotating a light receiver and a light transmitter. LiDAR sensors are largely divided into a spinning type LiDAR sensor that secures a viewing angle by rotating modules of a receiver (Rx) and a transmitter (Tx) and a mirror-rotating LiDAR sensor that secures a viewing angle by rotating a mirror while modules of a receiver and a transmitter are fixed.

The mirror-rotating LiDAR sensor is advantageous in terms of costs and miniaturization owing to structural characteristics thereof and thus has attracted much attention as a next-generation autonomous driving sensor.

Generally, the mirror-rotating LiDAR sensor uses a polygonal mirror and obtains a piece of scan data for each side of the mirror.

That is, a LiDAR sensor that rotates an n-side mirror may obtain n pieces of scan data for one rotation of a mirror.

However, in the case of a polygonal mirror rotating LiDAR sensor, each side of a mirror may distort by an angle due to a tolerance in a mirror production process, thus resulting in an error between pieces of LiDAR scan data.

Therefore, when LiDAR sensors are mass-produced, a calibration process is necessarily required to calibrate mirror distortion for each of the LiDAR sensors.

Korean Patent Laid-Open Publication No. 10-2020-0004873 (published on Jan. 14, 2020, entitled “Transmitter Optics for A LiDAR System, Optical Arrangement for A LiDAR System, LiDAR System and Working Device”) disclose a LiDAR system with a rotatable deflecting mirror.

As described above, LiDAR systems of the related art employ a technique for securing a horizontal viewing angle using a polygonal mirror on an assumption that sides of the mirror are the same.

It will be apparent that slight differences between sides of a polygonal mirror (e.g., a thickness or flatness difference that may occur in a production process), an angle difference due to distortion that may occur in an assembly process, and the like are major factors directly connected with the performance of a LiDAR system.

In the related art, a system is designed without considering the differences between features of sides of a polygonal mirror that are directly connected with the performance of a LiDAR system, and thus a position of an object detected by an actual LiDAR sensor product may not be the same in scan cycles of horizontal scanning.

### SUMMARY OF THE INVENTION

To address the above-described problem of the related art, the present disclosure is directed to providing an apparatus and method for calibrating an optical deviation between sides of a polygonal mirror of an individual light wave detection and ranging (LiDAR) sensor.

According to an aspect of the present disclosure, a calibration apparatus includes a calibration reference model with a vertical pillar, and a polygonal mirror rotating LiDAR sensor configured to obtain pieces of scan data including the vertical pillar of the calibration reference model, and calibrate positions of the vertical pillar in pieces of scan data on the basis of a position of the vertical pillar in a specific piece of scan data among the obtained pieces of scan data.

In an embodiment of the present disclosure, the polygonal mirror rotating LiDAR sensor and the calibration reference model may be fixedly installed at predetermined positions.

In an embodiment of the present disclosure, the polygonal mirror rotating LiDAR sensor may be replaceable.

In an embodiment of the present disclosure, the polygonal mirror rotating LiDAR sensor may include a transmitter configured to transmit laser light, a receiver configured to receive reflected light of the laser light from the transmitter, a polygonal mirror configured to be rotated to reflect the laser light from the transmitter to the calibration reference model and cause laser light reflected from the calibration reference model to the receiver, and a controller configured to control laser light output timing of the transmitter, and calculate a distance to the calibration reference model by calculating a difference between time when light is output from the transmitter and time when the light is received by the receiver.

In an embodiment of the present disclosure, the polygonal mirror may include mirrors and obtain pieces of scan data, wherein the number of the mirrors is an integer greater than or equal to 2 and is equal to the number of the pieces of scan data.

In an embodiment of the present disclosure, the controller may determine the reference scan data, and calibrate a degree to which the vertical pillar is shifted by calculating degrees to which the vertical pillar is shifted laterally in other pieces of scan data on the basis of a position of the vertical pillar in the reference scan data.

In an embodiment of the present disclosure, the controller may calibrate the degree to which the vertical pillar is shifted by adjusting output pulse timing of the transmitter.

In an embodiment of the present disclosure, the controller may convert the degrees to which the vertical pillar is shifted laterally into rotation angles of the polygonal mirror, and control the output pulse timing of the transmitter on the basis of the rotation angles.

According to another aspect of the present disclosure, a calibration apparatus includes a polygonal mirror rotating LiDAR sensor fixedly installed at a predetermined position and replaceable, and a calibration reference model fixedly installed at a predetermined position and including a vertical pillar to be detected by the polygonal mirror rotating LiDAR sensor, in which the polygonal mirror rotating LiDAR sensor may include a controller configured to obtain n pieces of scan data using n polygonal mirrors (n is an integer greater than or equal to 2) and calibrate positions of the vertical pillar in pieces of scan data on the basis of position data of the vertical pillar in a specific piece of scan data among the n pieces of scan data.

In an embodiment of the present disclosure, the controller may calculate degrees to which the vertical pillar is shifted laterally in n-1 pieces of scan data on the basis of a position of the vertical pillar in reference scan data among the n pieces of scan data, and control output pulse timing of a transmitter to calibrate the degrees to which the vertical pillar is shifted.

In an embodiment of the present disclosure, the controller may convert the degrees to which the vertical pillar is shifted laterally into rotation angles of the polygonal mirrors, and control the output pulse timing of the transmitter on the basis of the rotation angles.

According to another aspect of the present disclosure, a calibration method includes obtaining pieces of scan data of a calibration reference model, which includes a vertical pillar, while rotating a plurality of mirrors, determining reference scan data among the pieces of scan data, and calculating degrees to which the vertical pillar is shifted laterally in the other pieces of scan data on the basis of a position of the vertical pillar in the reference scan data, and calibrating the degrees to which the vertical pillar is shifted laterally in the other pieces of scan data to the position of the vertical pillar in the reference scan data.

In an embodiment of the present disclosure, a number of the pieces of scan data may be equal to that of the plurality of mirrors.

In an embodiment of the present disclosure, information about the degrees to which the vertical pillars are shifted laterally in the other pieces of scan data may include directionality information of the vertical pillar in the reference scan data.

The calibrating of the degrees to which the vertical pillar is shifted laterally may include adjusting pulse timing of transmission light.

The adjusting of the pulse timing of the transmission light may include converting the degrees to which the vertical pillar is shifted laterally into rotation angles of a polygonal mirror, and controlling output pulse timing of the transmission light on the basis of the rotation angles.

According to another aspect of the present disclosure, a calibration method includes a) obtaining n pieces of scan data by scanning a calibration reference model, which includes a vertical pillar, while rotating n polygonal mirrors, wherein n is an integer greater than or equal to 2, b) calculating degrees to which the vertical pillar is shifted laterally in n-1 pieces of scan data on the basis of location data or the vertical pillar in a specific piece of scan data among the n pieces of scan data, and c) controlling pulse timing of transmission light to compensate for the calculated degrees so as to control location data of the vertical pillar to be included at the same position in all the n pieces of scan data.

In an embodiment of the present disclosure, b) may include including directionality information into information about the degrees to which the vertical pillar is shifted laterally in the n-1 pieces of scan data.

In an embodiment of the present disclosure, c) may include converting the degrees to which the vertical pillar is shifted laterally into rotation angles of the polygonal mirror, and controlling output pulse timing of the transmission light on the basis of the rotation angles.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a structure of an apparatus for calibrating distortion of a polygonal mirror rotating light wave detection and ranging (LiDAR) sensor according to an embodiment of the present disclosure;

FIG. 2 illustrates an example of scan data before calibration;

FIG. 3 illustrates an example of scan data after calibration; and

FIG. 4 is a flowchart of a method of calibrating distortion of a polygonal mirror rotating LiDAR sensor of the present disclosure.

### DETAILED DESCRIPTION OF EXEMPLARY EMBODIMENTS

Hereinafter, embodiments of the present disclosure will be described in detail with reference to the accompanying drawings below so that they may be easily implemented by those of ordinary skill in the art. However, the present disclosure may be embodied in many different forms and is not limited to the embodiments set forth herein. For clarity, parts not related to explaining the present disclosure are omitted in the drawings, and the same reference numerals are allocated to the same or like components throughout the specification.

Embodiments of the present disclosure are provided below to more fully describe the present disclosure to those of ordinary skill in the art and may be embodied in many different forms but the scope of the present disclosure is not limited thereto. Rather, these embodiments are provided so that the present disclosure will be thorough and complete and will fully convey the concept of the present disclosure to those of ordinary skill in the art.

Terms used herein are for the purpose of describing embodiments only and are not intended to be limiting of the present disclosure. As used herein, singular forms may include plural forms unless the context clearly indicates otherwise. As used herein, the terms “comprises” and/or “comprising” specify the presence of stated shapes, integers, steps, operations, members, elements and/or groups thereof, but do not preclude the presence or addition of one or more other shapes, integers, steps, operations, members, elements and/or groups thereof. As used herein, the term “and/or” includes any and all combinations of one or more of the listed items.

Although the terms first, second, etc. are used herein to describe various members, regions, and/or parts, it will be obvious that these members, parts, regions, layers, and/or parts are not limited by these terms. These terms do not imply a specific order, top or bottom, or superiority or inferiority, and are only used to distinguish one member, region or part from another. Accordingly, a first member, region, or part described below may refer to a second member, a region, or a part without departing from the teachings of the present disclosure.

In the present specification, the terms “or” and “at least one” may refer to one of terms listed together or a combination of two or more of them. For example, the expression “A or B” and “at least one of A or B” indicates only A, only B, or both A and B.

Hereinafter, embodiments of the present disclosure will be described with reference to the drawings schematically illustrating embodiments of the present disclosure. It will be expected that shapes of components illustrated in the drawings may vary, for example, according to manufacturing technology and/or tolerances. Therefore, the embodiments of the present disclosure should not be construed as being limited by a specific shape of each region illustrated in the present specification but should be understood to cover, for example, a change in the shape of each region, caused during a manufacture process.

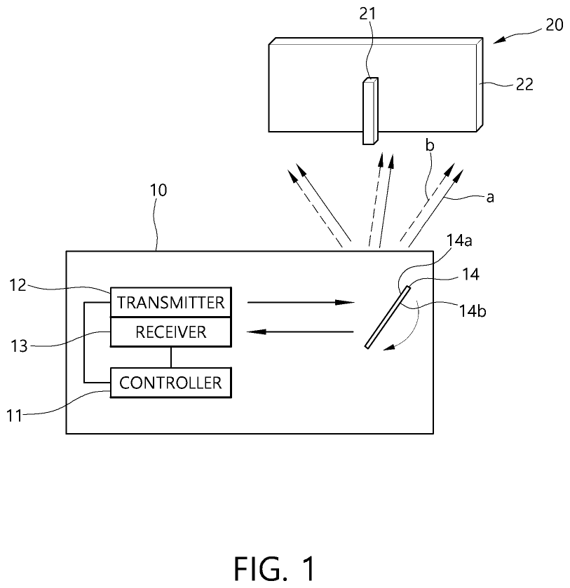

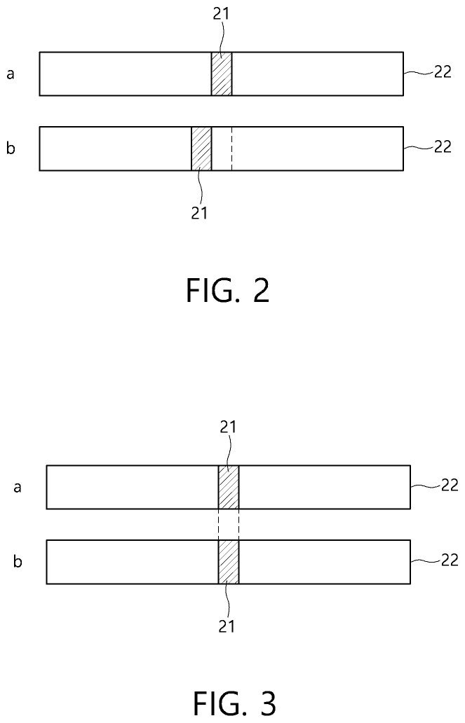

FIG. 1 is a diagram illustrating a structure of an apparatus for calibrating distortion of a polygonal mirror rotating light wave detection and ranging (LiDAR) sensor according to an embodiment of the present disclosure.

Referring to FIG. 1, the apparatus for calibrating distortion of a polygonal mirror rotating LiDAR sensor according to the embodiment includes a polygonal mirror rotating LiDAR sensor 10, and a calibration reference model 20 installed to be spaced apart from the polygonal mirror rotating LiDAR sensor 10 and providing a calibration reference point.

The polygonal mirror rotating LiDAR sensor 10 includes a transmitter 12 for transmitting laser light, a receiver 13 for receiving reflected light of the laser light from the transmitter 12, a polygonal mirror 14 configured to be rotated to reflect the laser light of the transmitter 12 to the calibration reference model 20 and cause laser light reflected from the calibration reference model 20 to be incident on the receiver 13, and a controller 11 for controlling laser light output timing of the transmitter 12 and calculating a distance to the calibration reference model 20 by calculating the difference between time when light is output from the transmitter 12 and time when the light is received by the receiver 13.

The calibration reference model 20 may include a vertical pillar 21 installed perpendicular to the ground, and a horizontal wall surface 22 spaced a certain distance from a rear surface of the vertical pillar 21 and installed horizontally with respect to the polygonal mirror rotating LiDAR sensor 10.

A structure and operation of an apparatus for calibrating distortion of a polygonal mirror rotating LiDAR sensor according to an embodiment of the present disclosure described above will be described in more detail below.

First, the polygonal mirror 14 is a rotating body with a first side 14a and a second side 14b, and may be a component including curved sides although the first side 14a and the second side 14b are illustrated as flat sides in FIG. 1.

Alternatively, the polygonal mirror 14 may include three or more reflective sides.

The present disclosure is directed to individually calibrating the polygonal mirror rotating LiDAR sensor 10, in which the polygonal mirror rotating LiDAR sensor 10 may be replaceable and a location and angle thereof are uniformly set to prevent changes of a distance to and an angle with respect to the calibration reference model 20.

Particularly, a jig may be provided to fix the polygonal mirror rotating LiDAR sensor 10.

When the polygonal mirror rotating LiDAR sensor 10 is disposed and operated, laser light is emitted from the transmitter 12, an angle of reflection of the laser light is changed through the polygonal mirror 14 that is rotating, and the laser light is emitted to the calibration reference model 20.

A first cycle of a scanning process as described above is performed through the first side 14a, and a second cycle thereof is performed by reflection through the second side 14b.

As shown in FIG. 1, the difference between a scan area A in the first cycle and a scan area B in the second cycle may occur due to the difference between the first side 14a and the second side 14b.

Such a difference may be detected by the receiver 13 that receives light reflected from the calibration reference model 20.

FIG. 2 illustrates an example of scan data received by the receiver 13 before calibration.

A position of the vertical pillar 21 of the calibration reference model 20 detected in the first cycle using the first side 14a may be different from that in the second cycle using the second side 14b due to the difference in angle between the first side 14a and the second side 14b of the polygonal mirror 14.

The controller 11 checks whether positions of the vertical pillar 21 in scan data a of the first cycle and scan data b of the second cycle are the same, and performs calibration such that the position of the vertical pillar 21 in the scan data a orb of the first or second cycle may match the position of the vertical pillar 21 in the scan data a or b of the other first or second cycle when the positions of the vertical pillar 21 are not the same.

In this case, the calibration may be performed by adjusting output light timing of the transmitter 12.

That is, distortion may be calibrated by determining a degree to which a detected object is shifted laterally by comparing pieces of scan data of sides of the polygonal mirror 14 with each other, converting the degree into a rotation angle, and adjusting output light pulse timing of the transmitter 12 by the rotation angle.

The above process may be repeatedly performed a plurality of times as necessary, and is performed until the position of the vertical pillar 21 becomes the same in the scan data a of the first cycle and the scan data b of the second cycle.

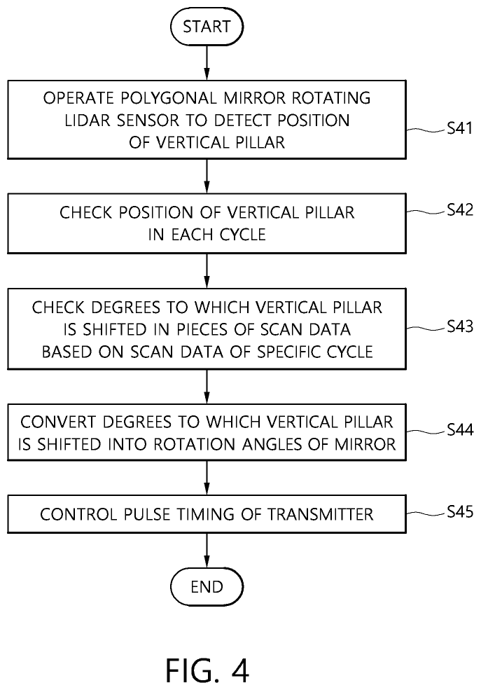

FIG. 4 is a flowchart of a method of calibrating distortion of a polygonal mirror rotating LiDAR sensor of the present disclosure.

Referring to FIG. 4, the method includes placing the polygonal mirror rotating LiDAR sensor 10 and the calibration reference model 20 at normal positions and operating the polygonal mirror rotating LiDAR sensor 10 (S41), checking a position of the vertical pillar 21 in pieces of scan data obtained in cycles (S42), checking degrees to which the vertical pillar 21 is shifted in pieces of scan data of other cycles on the basis of a position of the vertical pillar 21 in scan data of a specific cycle among the obtained pieces of scan data (S43), converting the degrees to which the vertical pillar 21 is shifted into rotation angles (S44), and controlling pulse timing of the transmitter 12 on the basis of the rotation angles of the polygonal mirror 14 such that the position of the vertical pillar 21 becomes in the pieces of scan data of all the cycles (S45).

A configuration and effect of a method of calibrating distortion of a polygonal mirror rotating LiDAR sensor according to the present disclosure described above will be described in more detail below.

First, in operation S41, the polygonal mirror rotating LiDAR sensor 10 and the calibration reference model 20 are placed at normal positions, and the polygonal mirror rotating LiDAR sensor 10 is operated.

In this case, the controller 11 controls laser light output pulse timing of the transmitter 12 by performing set timing control and rotates the polygonal mirror 14.

The polygonal mirror 14 may include n mirror sides (reflective sides) (n is an integer greater than or equal to 2), and each of the n mirror sides reflects light corresponding to scan data of one of cycles to perform scanning and causes light reflected from the calibration reference model 20 to be incident on the receiver 13.

Accordingly, pieces of scan data of n cycles may be obtained during one rotation of the polygonal mirror 14.

Next, in operation S42, the controller 11 checks positions of the vertical pillar 21 of the calibration reference model 20 in n pieces of scan data received by the receiver 13.

In this case, in a normal state, the vertical pillar 21 may be positioned at a midpoint in each of the n pieces of scan data. In the present disclosure, relative calibration is performed, and a position of the vertical pillar 21 in each piece of scan data is calibrated on the basis of a position of the vertical pillar 21 in scan data of a specific cycle as will be described below.

Next, in operation S43, degrees to which the vertical pillar 21 is shifted in the pieces of scan data of n-1 other cycles is checked on the basis of the position of the vertical pillar 21 in the scan data of the specific cycle.

In this case, the degrees to which the vertical pillar 21 is shifted may be identified in a left direction (i.e., a negative (−) direction) or a right direction (i.e., a positive (+) direction) with respect to a reference position, and directions of rotation angles converted from the degrees may be determined.

Next, in operation S44, n-1 degrees to which the vertical pillar 21 is shifted excluding a reference position of the vertical pillar 21 are converted into rotation angles of the polygonal mirror 14.

Thereafter, in operation S45, the controller 11 controls pulse timing of the transmitter 12 according to the rotation angles so that the positions of the vertical pillar 21 in the pieces of scan data of all the n cycles may be calibrated to be the same.

While embodiments of the present disclosure have been described above, the scope of the present disclosure is not limited thereto, and other embodiments may be easily derived by those of ordinary skill in the art who understand the spirit of the present disclosure by adding, changing, or deleting elements without departing from the scope of the present disclosure.

What is claimed is:

1. A calibration apparatus comprising:
a calibration reference model with a vertical pillar; and
a polygonal mirror rotating light wave detection and ranging (LiDAR) sensor configured to obtain pieces of scan data including the vertical pillar of the calibration reference model, and calibrate positions of the vertical pillar in pieces of scan data on the basis of a position of the vertical pillar in a specific piece of scan data among the obtained pieces of scan data.

2. The calibration apparatus of claim 1, wherein the polygonal mirror rotating LiDAR sensor and the calibration reference model are fixedly installed at predetermined positions.

3. The calibration apparatus of claim 2, wherein the polygonal mirror rotating LiDAR sensor is replaceable.

4. The calibration apparatus of claim 1, wherein the polygonal mirror rotating LiDAR sensor comprises:
a transmitter configured to transmit laser light;
a receiver configured to receive reflected light of the laser light from the transmitter;
a polygonal mirror configured to be rotated to reflect the laser light from the transmitter to the calibration reference model and cause laser light reflected from the calibration reference model to the receiver; and
a controller configured to control laser light output timing of the transmitter and calculate a distance to the calibration reference model by calculating a difference between time when light is output from the transmitter and time when the light is received by the receiver.

5. The calibration apparatus of claim 4, wherein the polygonal mirror comprises mirrors and obtains pieces of scan data, wherein the number of the mirrors is an integer greater than or equal to 2 and is equal to the number of the pieces of scan data.

6. The calibration apparatus of claim 5, wherein the controller determines reference scan data and calibrates a degree to which the vertical pillar is shifted by calculating degrees to which the vertical pillar is shifted laterally in other pieces of scan data on the basis of a position of the vertical pillar in the reference scan data.

7. The calibration apparatus of claim 6, wherein the controller calibrates the degree to which the vertical pillar is shifted by adjusting output pulse timing of the transmitter.

8. The calibration apparatus of claim 7, wherein the controller converts the degrees to which the vertical pillar is shifted laterally into rotation angles of the polygonal mirror, and controls the output pulse timing of the transmitter on the basis of the rotation angles.

9. A calibration apparatus comprising:
a polygonal mirror rotating light wave detection and ranging (LiDAR) sensor fixedly installed at a predetermined position and replaceable; and
a calibration reference model fixedly installed at a predetermined position and including a vertical pillar to be detected by the polygonal mirror rotating LiDAR sensor,
wherein the polygonal mirror rotating LiDAR sensor comprises a controller configured to obtain n pieces of scan data using n polygonal mirrors and calibrate positions of the vertical pillar in pieces of scan data on the basis of position data of the vertical pillar in a specific piece of scan data among the n pieces of scan data, wherein n is an integer greater than or equal to 2.

10. The calibration apparatus of claim 9, wherein the controller calculates degrees to which the vertical pillar is shifted laterally in n-1 pieces of scan data on the basis of a position of the vertical pillar in reference scan data among the n pieces of scan data, and control output pulse timing of a transmitter to calibrate the degrees to which the vertical pillar is shifted.

11. The calibration apparatus of claim 10, wherein the controller converts the degrees to which the vertical pillar is shifted laterally into rotation angles of the polygonal mirrors, and controls the output pulse timing of the transmitter on the basis of the rotation angles.

12. A calibration method comprising:
obtaining pieces of scan data of a calibration reference model, which includes a vertical pillar, while rotating a plurality of mirrors;
determining reference scan data among the pieces of scan data, and calculating degrees to which the vertical pillar is shifted laterally in other pieces of scan data on the basis of a position of the vertical pillar in the reference scan data; and
calibrating the degrees to which the vertical pillar is shifted laterally in the other pieces of scan data to the position of the vertical pillar in the reference scan data.

13. The calibration method of claim 12, wherein a number of the pieces of scan data is equal to that of the plurality of mirrors.

14. The calibration method of claim 12, wherein information about the degrees to which the vertical pillars are shifted laterally in the other pieces of scan data comprise directionality information of the vertical pillar in the reference scan data.

15. The calibration method of claim 12, wherein the calibrating of the degrees to which the vertical pillar is shifted laterally comprises adjusting pulse timing of transmission light.

16. The calibration method of claim 15, wherein the adjusting of the pulse timing of the transmission light comprises:
converting the degrees to which the vertical pillar is shifted laterally into rotation angles of a polygonal mirror; and
controlling output pulse timing of the transmission light on the basis of the rotation angles.

17. A calibration method comprising:
a) obtaining n pieces of scan data by scanning a calibration reference model, which includes a vertical pillar, while rotating n polygonal mirrors, wherein n is an integer greater than or equal to 2;
b) calculating degrees to which the vertical pillar is shifted laterally in n-1 pieces of scan data on the basis of location data or the vertical pillar in specific scan data among the n pieces of scan data; and
c) controlling pulse timing of transmission light to compensate for the calculated degrees so as to control location data of the vertical pillar to be included at the same position in all the n pieces of scan data.

18. The calibration method of claim 17, wherein b) comprises including directionality information into information about the degrees to which the vertical pillar is shifted laterally in the n-1 pieces of scan data.

19. The calibration method of claim 17, wherein c) comprises:
converting the degrees to which the vertical pillar is shifted laterally into rotation angles of the polygonal mirror; and
controlling output pulse timing of the transmission light on the basis of the rotation angles.
